(19) United States
(12) Patent Application Publication
(10) Pub. No.: US 2020/0342428 A1
(43) Pub. Date: Oct. 29, 2020

(54) TECHNIQUES FOR VIRTUAL DEPOSIT OF PAPER CURRENCY

(71) Applicant: Capital One Services, LLC, McLean, VA (US)

(72) Inventors: Abdelkader M'Hamed Benkreira, New York, NY (US); Michael Mossoba, Arlington, VA (US); Joshua Edwards, Philadelphia, PA (US)

(21) Appl. No.: 16/395,818

(22) Filed: Apr. 26, 2019

(51) Int. Cl. G06Q 20/10; G06Q 20/40

(52) U.S. Cl. CPC G06Q 20/108; G06Q 20/4016

(57) ABSTRACT

In one aspect, the present disclosure relates to a computer-implemented method for virtual deposit of paper currency. In some embodiments, the method may include receiving an indication from a device of a virtual deposit of paper currency to an account; receiving an image of the paper currency from the device; determining whether a virtual-deposit irregularity has occurred; in response to determining whether the virtual-deposit irregularity has occurred, crediting the account with at least a portion of the value of the virtually deposited paper currency; and providing a notification of a time period for physical deposit of the paper currency.

### BACKGROUND

As technology has developed, it has become commonplace to access one's bank account (e.g., savings account, checking account) electronically over a network, such as the Internet. For example, banks might offer websites, or software applications, that provide their customers with the convenience of accessing their accounts electronically. Some of these websites or applications also provide customers with the ability to move funds into or out of the account. However, there remain instances in which a customer cannot easily deposit funds into an account, and must travel to a physical office of the bank to make such a deposit.

### SUMMARY

Embodiments of the present disclosure relate to systems and methods for virtually depositing paper currency. In addition, embodiments of the present disclosure relate to solutions that mitigate risks to a financial institution of providing for virtual deposit of paper currency.

In accordance with some embodiments of the present disclosure, there is provided a computer-implemented method for virtual deposit of paper currency. The method includes receiving, by a computer system including a processor, an indication from a device of a virtual deposit of paper currency to an account. The method also includes receiving, by the computer system, an image of the paper currency from the device, and identifying, by the computer system, a value of the paper currency from the image. The method further includes identifying, by the computer system, a distinguishing feature of the paper currency from the image, and determining, by the computer system, whether a virtual-deposit irregularity has occurred by comparing the distinguishing feature with information stored in a database. The method still further includes, in response to determining whether the virtual-deposit irregularity has occurred, crediting, by the computer system, the account with at least a portion of the value of the paper currency. The method also includes providing, by the computer system to the device, a notification of a time period for physical deposit of the paper currency.

In accordance with aspects of the disclosure, the virtual-deposit irregularity occurs in response to a determination that the paper currency has been virtually deposited at a frequency greater than a threshold target.

In accordance with further aspects of the disclosure, the virtual-deposit irregularity occurs in response to a determination that the paper currency has been virtually-deposited more than once within a defined time span from devices whose locations at a time of virtual deposit were separated by a distance greater than a target distance.

In accordance with still further aspects of the disclosure, the method includes debiting, by the computer system, the account of at least the portion of the value of the paper currency that was credited if the paper currency is not physically deposited within the time period.

In accordance with aspects of the disclosure, the method includes receiving, by the computer system, an indication that a user is attempting to complete the virtual deposit by physically depositing the paper currency. The method also includes determining, by the computer system, that a completion irregularity has occurred in response to the indication that the user is attempting to complete the virtual deposit. The method further includes debiting, by the computer system, from the account at least the portion of the value of the virtually deposited paper currency, and providing, by the computer system to the device, a notification of the debit to the account.

In accordance with further aspects of the disclosure, the completion irregularity occurs in response to an inconsistency between the value of physically deposited paper currency and the value of the paper currency that was virtually deposited, a determination that the physically deposited paper currency is not identical to the paper currency in the image, an indication that the physically deposited paper currency is counterfeit, or a determination that the virtual deposit was fraudulent.

In accordance with still further aspects of the disclosure, the method includes triggering, by the computer system, a process that allows a user of the device to capture the image of the paper currency.

In accordance with aspects of the disclosure, the image is captured utilizing a camera built into the device.

In accordance with further aspects of the disclosure, the image is captured through use of an application provided by an institution offering the account.

In accordance with still further aspects of the disclosure, the portion of the value and the time period are based on attributes associated with the account.

In accordance with aspects of the disclosure, the method includes receiving, by the computer system, an indication that the paper currency has been physically deposited, crediting, by the computer system, the account of any value of the paper currency that was not already credited to the account, and providing, by the computer system to the device, a notification of the credit to the account.

Furthermore, in accordance with some embodiments, there is provided an automated teller machine for completing a virtual deposit of paper currency, including a memory storing instructions and a processor. The processor, when executing the instructions, is configured to receive a credential from a user associated with the account, and receive an indication that a user wishes to physically deposit paper currency that was previously deposited to the account by virtual deposit. The processor, when executing the instructions, is also configured to prompt the user to insert the paper currency corresponding to the virtual deposit, and perform image recognition on the paper currency to identify a value and a distinguishing mark of the paper currency. The processor, when executing the instructions, is further configured to send an indication of the value and an indication of the distinguishing mark over a network to a computer system, and receive a notification over the network from the computer system indicating whether the paper currency is accepted as a physical deposit.

In accordance with aspects of the disclosure, the processor, when executing the instructions, is configured to present a confirmation to the user when the notification indicates that the paper currency is accepted.

In accordance with further aspects of the disclosure, the processor, when executing the instructions, is configured to present information to the user that the paper currency has been denied when the notification indicates that the paper currency is not accepted, and return the paper currency to the user.

In accordance with still further aspects of the disclosure, the notification is received in response to an inconsistency between the value of the paper currency and the value of the paper currency that was deposited by virtual deposit, a determination that the paper currency is not identical to the paper currency that was deposited by virtual deposit, an indication that the paper currency is counterfeit, or a determination that the virtual deposit was fraudulent.

Further still, in accordance with some embodiments, there is provided a computer-implemented method for virtual deposit of paper currency. The method includes receiving, by a device including a processor, user input indicating that a user wishes to deposit paper currency to an account by virtual deposit. The method also includes triggering, by the device, a process that allows the user to capture an image of the paper currency, and sending, by the device, the image of the paper currency to a computer system associated with the account. The method further includes receiving, by the device, a notification from the computer system regarding a status of the virtual deposit.

In accordance with aspects of the disclosure, the notification indicates that the virtual deposit has been accepted and a time period for physical deposit of the paper currency.

In accordance with further aspects of the disclosure, the institution indicates that a virtual-deposit irregularity has occurred and that the virtual deposit has not been accepted.

In accordance with still further aspects of the disclosure, the virtual-deposit irregularity occurs in response to a determination that the paper currency has been virtually deposited at a frequency greater than a threshold target, or a determination that the paper currency has been virtually deposited more than once within a defined time span from devices whose locations at a time of virtual deposit were separated by a distance greater than a target distance.

In accordance with aspects of the disclosure, the image is captured utilizing a camera built into the device.

Before explaining example embodiments consistent with the present disclosure in detail it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings, which are incorporated in and constitute a part of this specification, and together with the description, illustrate and serve to explain the principles of various example embodiments.

FIG. 1 is a block diagram illustrating an example computing environment, consistent with embodiments of the present disclosure.

FIG. 2 is a flow diagram of an example method of virtually depositing paper currency, consistent with some embodiments of the present disclosure.

FIG. 3 is a flow diagram illustrating an example method of completing a virtual deposit of paper currency, consistent with some embodiments of the present disclosure.

FIG. 4 is a flow diagram illustrating another example method of virtually depositing paper currency, consistent with some embodiments of the present disclosure.

FIG. 5 is a block diagram illustrating an example computer system, consistent with some embodiments of the present disclosure.

### DETAILED DESCRIPTION

In the following description, numerous specific details are set forth regarding the systems and methods of the disclosed subject matter and the environment in which such systems and methods may operate in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

Embodiments of the present disclosure relate to systems and methods for virtually depositing paper currency. In addition, embodiments of the present disclosure relate to solutions that mitigate risks to a financial institution of providing for virtual deposit of paper currency.

As technology has developed, it has become commonplace to access one's bank account (e.g., savings account, checking account) electronically over a network, such as the Internet. For example, banks might offer websites, or software applications, that provide their customers with the convenience of accessing their accounts electronically. Some of these websites or applications also provide customers with the ability to move funds into or out of the account. However, there remain instances in which a customer cannot easily deposit funds into an account, and must travel to a physical office of the bank to make such a deposit.

Embodiments of the present disclosure can improve the ability of a customer to deposit funds into an account. For example, a customer may need to deposit paper currency (e.g., cash) to a banking account, such as a savings account or checking account, but may not have easy access or time to travel to a physical branch of the banking institution. The customer may also have some urgency to deposit the paper currency, such as if the customer needs to pay out of the account funds in the near future. Embodiments of the present disclosure can improve the ability of a customer to virtually deposit paper currency to get a temporary credit in their banking or savings account that corresponds to the value of the paper currency, which the customer can then draw against. The financial institution may credit the customer's account with the understanding that the customer will deposit the bills that were virtually deposited, or at least bills corresponding to the value that was virtually deposited, within a certain period of time. The customer may virtually deposit the paper currency by taking one or more images of the bills of the paper currency (e.g., by taking a picture of the bills, by scanning the bills with a scanner), and then sending those images to the financial institution for virtual deposit.

The use of paper currency, as opposed to checks, for these types of transactions may carry risk of error, fraud and counterfeiting, because paper currency is fungible and reusable. According to some embodiments of the present disclosure, the systems and methods for depositing paper currency may allow a person to use a smart phone, tablet, personal computer (PC) or other Internet-enabled device to send a digital image of the paper currency, along with data about the person's account and the amount of the paper currency, to a recipient. At some later point in time, the person may complete the deposit by submitting the physical paper currency on which the image was captured to a bank teller, a night-deposit box or an automated teller machine (ATM). The systems and methods may include checks and balances to ensure that technical errors, human errors, fraud and counterfeiting are detected and managed. In particular, the systems and methods may include steps to minimize risks associated with such occurrences.

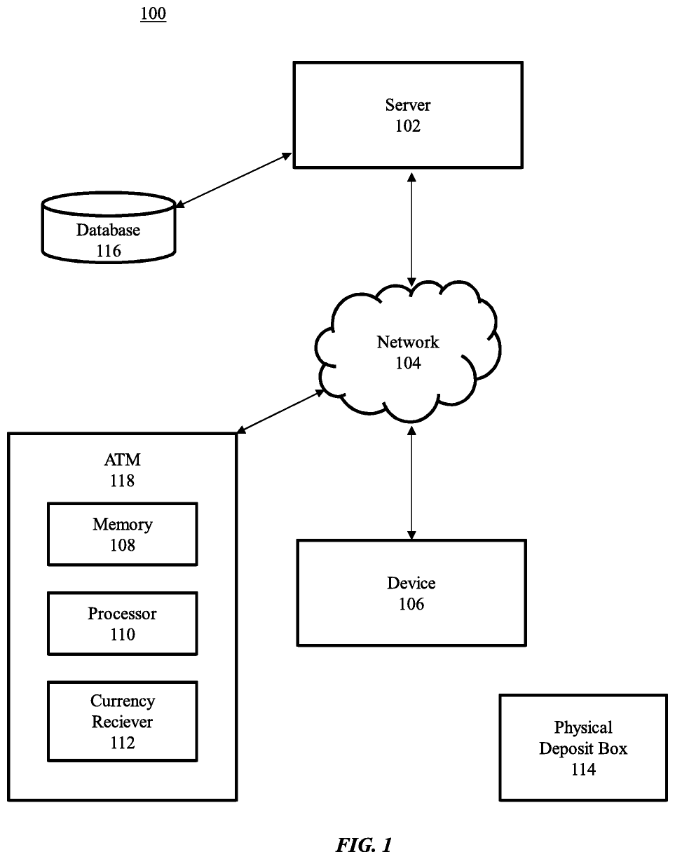

FIG. 1 illustrates a block diagram of an example computing environment 100 for implementing embodiments and features of the present disclosure. The arrangement and number of components in environment 100 is provided for purposes of illustration. Additional arrangements, numbers of components, and other modifications can be made, consistent with embodiments of the present disclosure.

As shown in FIG. 1, in some embodiments, computing environment 100 may include one or more client devices 106, connected to a server 102 over a network 104. Server 102 may include a database 116, or may be connected to a database 116 over a network 104. Computing environment 100 may include a physical deposit box 114, a live-teller station (not shown), and/or an automated teller machines (ATM) 118.

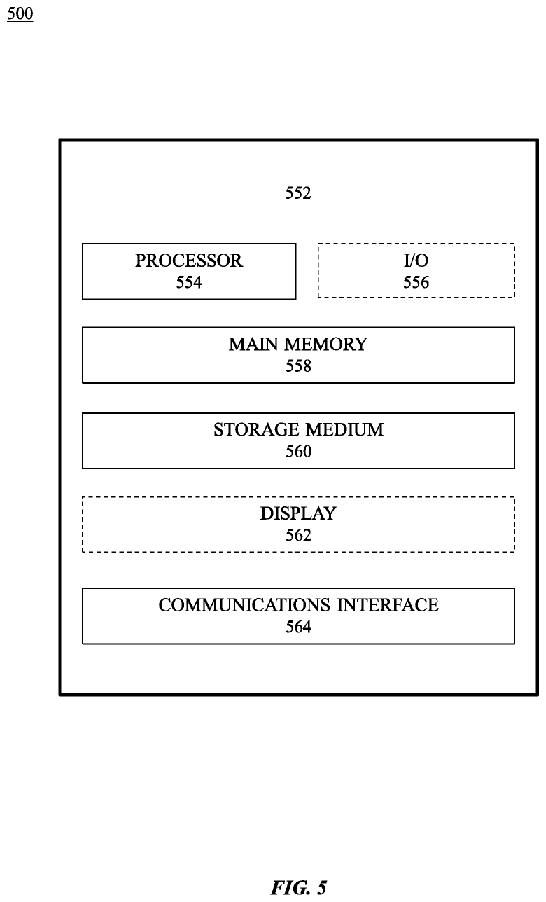

In some embodiments, computing environment 100 may include one or more client devices 106. The example provided in computing environment 100 illustrates one client device 106; however, the disclosure is not limited to one client device. A client device 106 may be a mobile phone, a smart phone, a tablet, a netbook, an electronic reader, a personal digital assistant (PDA), a personal computer, a laptop computer, a dumb terminal, a smart watch, a gaming device, a desktop computer, a set-top box, a smart television, a personal organizer, a portable electronic device, a smart appliance, a navigation device, or another type of computing device. In some embodiments, a client device 106 may be implemented with hardware devices, software applications running on the hardware devices, or both. A user may use a client device 106 to communicate with server 102 over network 104. A client device may communicate by transmitting data to or receiving data from server 102. In some embodiments, one or more client devices 106 may be implemented using a computer system, such as computer system 500 of FIG. 5.

In some embodiments, computing environment 100 may also include one or more servers 102. By way of example, server 102 may include any combination of one or more of web servers, mainframe computers, general-purpose computers, personal computers, or other types of computing devices. In some embodiments, server 102 may be configured to host a web page, implement a search engine, provide an online bill payment center, provide online account access, provide online transactions, index information, store information, retrieve information, or some combination of these functions. In some embodiments, a server 102 may be a standalone computing system or apparatus, or it may be part of a larger system. For example, server 102 may represent distributed servers that are remotely located and communicate over a communications network, or over a dedicated network such as a local area network (LAN). Server 102 may include one or more back-end servers for carrying out one or more aspects of the present disclosure.

In some embodiments, server 102 may be implemented as a server system including a plurality of servers, or a server farm including a load balancing system and a plurality of servers. In some embodiments, a server 102 may be implemented with hardware devices, software applications running on the hardware device or both. A server 102 may communicate with client device(s) 106 over one or more networks 104, and may also communicate with one or more databases 116 over network(s) 104. For example, a server 102 may communicate by transmitting data to or receiving data from client devices or account databases or both. In some embodiments, server 102 may be implemented using a computer system.

In some embodiments, computing environment 100 may also include one or more databases 116. A database 116 may be a part of a server 102, or may be connected with a server 102 over one or more networks. Database 116 may include any combination of one or more types of databases, such as hierarchical databases, network databases, relational databases, or object-oriented databases. A database 116 may store information related to an account, such as the account holder's name, account number, account balance, mailing address, email address, telephone number, credit limit, or any other type of information related to a person's banking. This information may, for example, be stored in a record associated with the person. A database 116 may store a large collection of records associated with a number of accounts. A database 116 may be searchable, such that a server 102 or client device can execute a query against the database 116 to retrieve records or information associated with accounts. In response to such a query, a server 102 or client device may receive a list of one or more records or results that may match the submitted query. A database 116 may be implemented in software, or in a combination of software and hardware.

In some embodiments, database 116 may be included within server 102, or may be connected to server 102 over one or more networks. A network may provide for the exchange of information, such as queries for information and results, between server 102 and database. A network may include one or more wide area networks (WANs), metropolitan area networks (MANs), local area networks (LANs), personal area networks (PANs), or any combination of these networks. A network may include a combination of one or more types of networks, such as Internet, intranet, Ethernet, twisted-pair, coaxial cable, fiber optic, cellular, satellite, IEEE 802.11, terrestrial, or other types of wired or wireless networks. In some embodiments, database 116 may be implemented using a computing system.

In some embodiments, computing environment 100 may include one or more physical deposit boxes 114 (e.g., a night-deposit box at a bank). As used herein, the term “deposit” may refer to any financial transaction in which money is transferred from one entity to another. A deposit may be the transfer of money into a checking or savings account, a transfer of money into a money market or brokerage account, a transfer of money to secure a contract, a transfer of money in exchange for goods or services, or a transfer of money to settle a debt. The term “paper currency,” as used herein, may refer to any form of paper currency of any denomination. The paper currency may be U.S. dollar bills, European Union Euro bills, Canadian dollar bills, Chinese Yuan bills, British Pound notes, or any other form of legal tenderable paper currency. Paper currency may also be referred to as cash or bill. The term “account,” as used herein, may refer to any type of financial account (e.g., a checking account, savings account, money market account, brokerage account, escrow account), any type of debt account (e.g., student loan, mortgage loan, retail IOU), or any type of account for receiving money in exchange for goods or services (e.g., payment in advance for medical care, education, rents).

In some embodiments, computing environment 100 may include one or more automated teller machines (ATM) 118. An ATM 118 may include a display device (not shown), an input device (not shown), a paper currency receiver 112, a paper currency dispenser (not shown), or a card reader (not shown). In some embodiments, the display device and the input device may collectively be provided as a touchscreen device. In some embodiments, the input device may be provided as a numeric or alphanumeric keypad. ATM 118 may also include a wired or wireless network adapter (not shown) configured to communicate with server device 102 via first network 104. An ATM 118 may include a processor 110 for executing machine instructions or a memory 108 for storing executable instructions.

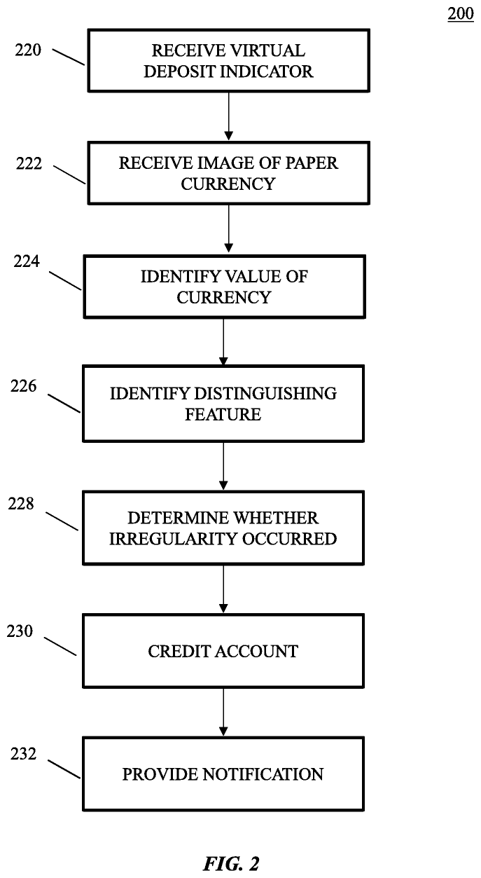

FIG. 2 illustrates a flowchart of an example method 200 for virtually depositing paper currency, consistent with some embodiments of the present disclosure. In some embodiments, method 200 may include: in step 220 receiving an indication from a device of a virtual deposit of paper currency to an account; in step 222, receiving an image of the paper currency from the device; in step 224, identifying the value of the paper currency from the image; in step 226, identifying a distinguishing feature of the paper currency from the image; in step 228, determining whether a virtual-deposit irregularity has occurred by comparing the distinguishing feature with information stored in a database; in step 230, crediting the account with at least a portion of the value of the virtually deposited paper currency if the virtual-deposit irregularity has not occurred; and in step 232, providing a notification of a time period for physical deposit of the paper currency. Example method 200 may be implemented in a computing environment (see, e.g., FIG. 1) using one or more computer systems (see, e.g., FIG. 5). In some embodiments, method 200 may be performed by one or more servers 102.

In step 220, receiving an indication from a device of a virtual deposit of paper currency to an account may include receiving a notification or a process call from a computing device such as a personal computer, smart phone or tablet. The indication may be received over one or more networks, such as network(s) 104 of FIG. 1.

In step 222, receiving an image of the paper currency from the device may include receiving one or more files containing one or more digitally encoded images. The image may be received via one or more networks, such as network(s) 104 illustrated in FIG. 1. The step of receiving an image may include triggering a process that allows the user to capture an image of the paper currency. The image may be captured, for example, by a scanner or a camera. The image may be captured utilizing a camera built into the device through which the user is making the virtual deposit (e.g., a smartphone camera). The process for capturing an image may be an internal part of the virtual paper-currency deposit system (e.g., a subroutine of the main computer program). Alternatively, the process for capturing an image may be external to the virtual paper-currency deposit system (e.g., an application that is resident on the device through which the user is making the virtual deposit, a camera application on a smartphone, a scanner program). The image may be captured through use of an application provided by an institution offering the account or an application provided by any other entity. Requiring that the image be submitted by an internal process may prevent the image from being shared with other users or from being submitted multiple times in error, thus decreasing the incidence of error or fraud and mitigating risk to a financial institution. The step of receiving an image of the paper currency from the device may include receiving multiple images. An image of the paper currency may include representation of a single bill in each image or multiple bills in each image. The receiving step may include receiving images of both sides of each paper currency of the virtual deposit.

In step 224, identifying the value of the paper currency from the image may include executing a process that can detect and read serial numbers from paper currency and looking up the serial numbers in a database to determine a nominal value of the paper currency. The step of identifying the value may include executing a process that can detect and read the value directly from the paper currency image. The step of identifying the value may include executing a process that can detect visual or encoded indicators of the value directly on the paper currency image (e.g., certain pictorial elements may indicate the type and value of a bill, holographic, barcode or invisible marks may indicate the type and value of a bill, ink color may indicate the type and value of a bill). Reading serial numbers and denomination may help to decrease losses by eliminating fraudulent deposits and identifying counterfeit bills. For example, if an image is submitted with a number of bills having the same serial number and denomination, it may be recognized as an irregularity to be handled, because each bill in circulation should have a unique serial number for each denomination.

In step 226, identifying a distinguishing feature of the paper currency from the image may include digitizing or otherwise recording any anomaly on a bill (e.g., a tear, a serial number, handwriting, a smudge, fading of color, a wrinkle).

In some embodiments, irregularities in the virtual deposit of paper currency may occur at the virtual deposit stage (i.e., a virtual-deposit irregularity) or at the stage where the physical paper currency is surrendered to complete (otherwise referred to herein as “perfect”) the virtual deposit (i.e., a completion irregularity). In step 228, determining whether a virtual-deposit irregularity has occurred may include comparing the paper currency value or one or more distinguishing features of paper currency to images of, or information about, paper currency deposited in other virtual deposits that may be stored in a database. A virtual-deposit irregularity may occur when the virtual deposit is taking place. For example, a nominal value, serial number, handwriting on the paper currency, and/or tears in the paper currency may be distinguishing features that may be compared to distinguishing features of paper currency images from other deposits stored in the database. If there is a match between distinguishing features of paper currency being virtually deposited and paper currency suspected of being fraudulent or counterfeit, a virtual-deposit irregularity may occur and the virtual deposit may be flagged and/or not allowed to proceed. Likewise, if there is a mismatch between a distinguishing feature of paper currency being virtually deposited and paper currency that has previously been virtually deposited (e.g., a mismatch in serial numbers from bills that otherwise look identical), a virtual-deposit irregularity may occur and the virtual deposit may be flagged and/or not allowed to proceed. By identifying such virtual-deposit irregularities, fraud or technical or human error can be detected and prevented.

As another example, the system may detect and flag as a virtual-deposit irregularity, any virtual deposit of paper currency that appears to have been virtually deposited at a frequency greater than a threshold target (e.g., the same bill being deposited more than 3 times in 24 hours), any virtual deposit of paper currency that appears to have been deposited more than once at locations that were so far apart in distance that it was not possible for the bills to have been virtually deposited, physically surrendered, redistributed and then relocated for a second legitimate virtual deposit within the time span between virtual deposits (e.g., a virtual deposit was attempted in San Francisco with a bill that had been virtually deposited in Chicago only 20 minutes earlier), or any virtual deposit of paper currency that is determined to be improper. This process of identifying a virtual-deposit irregularity adds value by preventing erroneous crediting of a virtual deposit to a depositor when the customer attempted the virtual-deposit through error or fraud. Accordingly, the method may detect when a depositor attempts to deposit the same bill multiple times, and may be used to prevent a situation where the customer virtually-deposits a bill and then gives the same bill to another party to also deposit. The described virtual-deposit irregularity may prevent a virtual-deposit where a single person makes a virtual-deposit multiple times. The virtual-deposit irregularity may also prevent a virtual-deposit where one person deposits paper currency by virtual deposit, and then another person unknowingly attempts to deposit the same paper currency before the physical bills have been deposited to the financial institution. In this way, the system may detect indicators of error or fraud regardless of whether the error or fraud was intentional (i.e., fraudulent), and regardless of whether there was a counterfeiting issue known or unknown to the depositor.

Tracking distinguishing marks may be uniquely valuable because distinguishing marks on the bills may allow the bank to more easily determine whether a bill is the same bill that a bank had received by virtual deposit multiple times. Such a situation may indicate that there is an individual intentionally trying to defraud them. The bank may also more easily determine whether they had received multiple different bills with the same denomination and serial number but different surface markings (e.g., handwriting, tears), in which case there may be a counterfeiting issue. The described method has the added benefit of helping banks to locate counterfeit bills that are in circulation. Because the images may be uploaded into a central database where a computer system can review, compare, analyze and identify duplicate bills, counterfeit currency can be identified and appropriate parties can be notified to remove the counterfeit currency from circulation. Such a system may be instrumental in identifying individuals who are engaging in criminal behavior as well as in managing losses of people who are witlessly carrying counterfeit bills.

In step 230, crediting the account may include incrementing an amount of money in a deposit account or debiting an amount of money owed, with some portion of the value of the virtually deposited paper currency (e.g., with some percentage between 0 and 100% of a total value of the virtual deposit). The step of crediting may not be executed if a virtual-deposit irregularity occurred. The portion of the value of the virtually deposited paper currency may be determined based on attributes of the account or account holder (e.g., if the account holder has been a customer for a certain amount of time, the portion may be larger, whereas, if the account was opened in the last 18 months, the portion may be smaller).

In step 232, providing a notification may include providing instructions to the virtual depositor that the physical paper currency must be surrendered (i.e., physically deposited) to complete the virtual deposit and release the balance of the funds of the virtual deposit. The instruction may include an indication of a time period for physical deposit of the paper currency. The time period for physical deposit of the paper currency may be based on attributes of the account holder or the account (e.g., if the account holder has been a customer for a certain amount of time, the time period may be longer, whereas, if the account was opened in the last 3 months, the time period may be shorter).

The instruction may include instructions regarding how the virtual depositor may go about surrendering (i.e., physically depositing) the paper currency. Physically depositing the paper currency that was virtually deposited may include surrendering the paper currency at a bank teller, through an ATM, to a physical deposit box, to a designated vendor or retailer, or through some other means established by the receiver of the virtual deposit.

In some embodiments, a virtual paper-currency deposit system may include a step of debiting the account of the credited portion if the paper currency is not physically deposited within the time period. For example, if the institution providing the account credits $100 of a virtual deposit to the account, and, after three days the paper currency has not been surrendered through any of the instructed mechanisms, the $100 may be debited from the account in order to negate the virtual deposit.

In some embodiments, a method of virtually depositing paper currency may include steps of receiving an indication that the paper currency has been physically deposited, crediting the account, and notifying the user that the virtual deposit has been perfected through physical deposit of the paper currency. Receiving an indication may include receiving a record from a computing device such as a mainframe. The indication may be received over one or more networks, such as network(s) 104 of FIG. 1. After physical deposit of the paper currency that had been virtually deposited is completed, the account may be credited with any value of the paper currency that was not already credited to the account (e.g., if $100 of a $250 virtual deposit was credited when the virtual deposit was made, the remaining $150 may be credited when the paper currency was physically deposited).

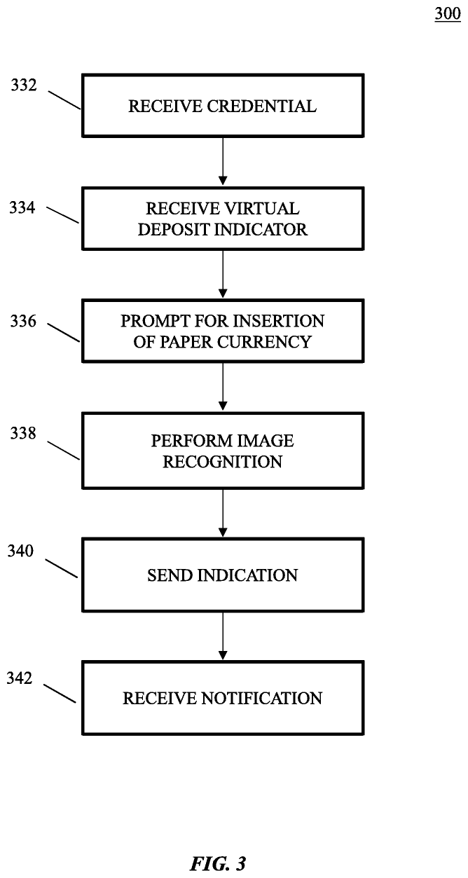

FIG. 3 is a flow diagram illustrating an example method 300 of completing a virtual deposit of paper currency, consistent with some embodiments of the present disclosure. In some embodiments, method 300 may include: in step 332, receiving a credential associated with a user; in step 334, receiving a virtual deposit indicator indicating that the user had deposited paper currency by virtual deposit; in step 336, prompting the user for insertion of the paper currency that corresponds to the virtual deposit; in step 338, performing image recognition on the paper currency the user inserted; in step 340, sending an indication of the paper currency inserted by the user to one or more servers (e.g., server(s) 102) associated with a financial institution; and in step 342, receiving a notification indicating whether the virtual deposit has been perfected through the insertion of paper currency that corresponds to the paper currency that was virtually deposited. Example method 300 may be implemented in a computing environment (see, e.g., FIG. 1) using one or more computer systems (see, e.g., FIG. 5). In some embodiments, method 300 may be performed by one or more ATMs 118.

In step 332, a credential may be received. For example, an ATM may receive a credential associated with a user's bank account, such as insertion of a card (e.g., debit card) and entry of a personal identification number (PIN) on a screen of the ATM. Alternatively, the user may enter different information for identifying the bank account, such as a username and password, or an account number and/or routing number.

In step 334, a virtual deposit indicator may be received. For example, the ATM may receive a selection from the user indicating that physical currency had been virtually deposited. The user may identify a virtual deposit with an identification number associated with the virtual deposit. Alternatively, the user may, after selecting an option to perfect a virtual deposit, be presented with a list of one or more virtual deposits in the user's account that still need to be perfected, and the user may select a virtual deposit from that list. In some embodiments, the user may simply select that a virtual deposit needs to be perfected without selecting a particular virtual deposit. In some embodiments, the ATM may prompt the user with a notification indicating that a virtual deposit needs to be perfected on an initial screen after the user has presented the credential to the ATM.

In step 336, a prompt for insertion of currency may be displayed. For example, the ATM may prompt the user with a screen indicating that the user may deposit physical currency corresponding to the virtual deposit. In some embodiments, the ATM may contact a server, such as server(s) 102, to determine which paper currency was virtually deposited by the user, and may receive this information from the server. The ATM may then prompt the user with the particular serial numbers and denominations of the bills that the user had virtually deposited, so that the user knows which bills to insert. Alternatively, the ATM may present the user with a value of the paper currency that was virtually deposited, and may request that the user insert a combination of bills that equals this value.

In step 338, image recognition may be performed. For example, the ATM may perform image recognition on the inserted paper currency to identify one or more distinguishing features of the bills. The distinguishing features may include one or more of a denomination, serial number, mark, writing, tear, and/or wrinkle. In some embodiments, image recognition may be performed to identify a combination of a denomination and a serial number for each of the bills that were inserted. In some embodiments, image recognition may be performed to identify a total value of the bills that were inserted. In some embodiments, rather than perform image recognition, the ATM may take images of the inserted bills and send the images to server(s) 102 over network(s) 104, and server(s) 102 may then perform the image recognition.

In step 340, an indication may be sent. For example, the ATM may send an indication over network(s) 104 to server(s) 102 indicating the physical bills the user has inserted. If the ATM performed image recognition on the bills, the indication may identify one or more distinguishing features of the bills. The distinguishing features may include, for example, one or more of a denomination, serial number, mark, writing, tear, and/or wrinkle for one or more of the bills. In some embodiments, the indication may include at least a combination of the denomination and serial number for each of the bills. In some embodiments, the indication may include one or more images of the paper currency, and server(s) 102 may perform image recognition on the images.

In step 342, a notification may be received. For example, the ATM may receive information back from server(s) 102 indicating whether the inserted physical bills have been accepted as a physical deposit. In some embodiments, the ATM may receive information back from server(s) 102 indicating whether a virtual deposit has been perfected based on insertion of the physical bills. For example, if server(s) 102 determine that the inserted bills correspond to the paper currency that was deposited by virtual deposit, and that a completion irregularity has not occurred, the ATM may receive a notification from server(s) 102 indicating that the virtual deposit has been perfected. In some embodiments, if server(s) 102 determine that the value of the inserted bills corresponds to the value of the paper currency that was deposited by virtual deposit, and that a completion irregularity has not occurred, the ATM may receive a notification from server(s) 102 indicating that the virtual deposit has been perfected.

In some embodiments, if server(s) 102 determine that a completion irregularity has occurred, the ATM may receive a notification from server(s) 102 indicating an error and a reason for the error. The error may include, for example, an indication that the bills inserted are not the same as the bills that were virtually deposited. In some embodiments, the error may include an indication that the value of the inserted bills does not amount to the same value of paper currency that was virtually deposited. In some embodiments, the error may include an indication that a predetermined threshold number or percent of the virtually deposited bills do not match the inserted bills. For example, if a user virtually deposited twenty-five bills, then inserts a number of bills, and only one of the inserted bills matches a virtually deposited bill, an error may be returned indicating that a large number of the virtually deposited bills have still not been perfected. In some embodiments, the error may include an indication that the inserted bills were not inserted within an amount of time required to perfect the virtual deposit. In some embodiments, the error may include an indication that the inserted bills may be fraudulent, or that the bills may have been inserted by the user for fraudulent reasons or by mistake. In some embodiments, the ATM may display a prompt to the user providing information regarding the notification received by the ATM, such as a confirmation that the virtual deposit has been perfected, or a message indicating that perfection of the virtual deposit has been denied along with a reason why it has been denied.

Situations in which a virtual deposit is not perfected, such as due to a completion irregularity, may be handled in different ways. In some embodiments, if a completion irregularity occurs, the inserted bills may still be deposited despite the error condition, but the user may be prevented from conducting future virtual deposits, at least for some period of time. For example, if a user virtually deposited a number of bills totaling a particular value, and then inserted physical bills that were not identical to the virtually deposited bills but equaled the virtually deposited bills in value, the inserted bills may be deposited and the virtual deposit may be considered perfected, but the user may be penalized by preventing the user from conducting future virtual deposits at least for some period of time (e.g., 3 months). In some embodiments, if server(s) 102 determine (e.g., by comparing one or more distinguishing marks of the bills with one of more distinguishing marks of bills stored in a database), that one or more of the inserted bills is likely to be counterfeit or otherwise fraudulent, the ATM may refuse to deposit the bills and may return the bills to the user. Alternatively, if server(s) 102 determine that only some of the inserted bills are likely to be counterfeit or otherwise fraudulent, the inserted bills not determined as likely to be counterfeit or fraudulent may be deposited, and the virtual deposit amount may be adjusted in value by the amount of the deposited bills. The remaining bills may be returned to the user. Similarly, if server(s) 102 determine that only some of the inserted bills match bills that were virtually deposited, the inserted bills that match may be deposited and the virtual deposit amount may be adjusted in value by the amount of the deposited bills. The remaining bills may be returned to the user, or deposited in the user's account but not considered towards perfecting the virtual deposit.

In some embodiments, step 334 may not be included in method 300. For example, rather than have the user identify a virtual deposit that needs to be perfected, the ATM may create images of all inserted bills, and the ATM or server(s) 102 (after receiving one or more image(s) of the inserted bills or information about the inserted bills) may automatically match inserted bills with any virtually deposited bills. In doing so, a user may insert bills for deposit without considering whether each of the bills corresponds to a virtually deposited bill, while still perfecting virtual deposit of any bills that match.

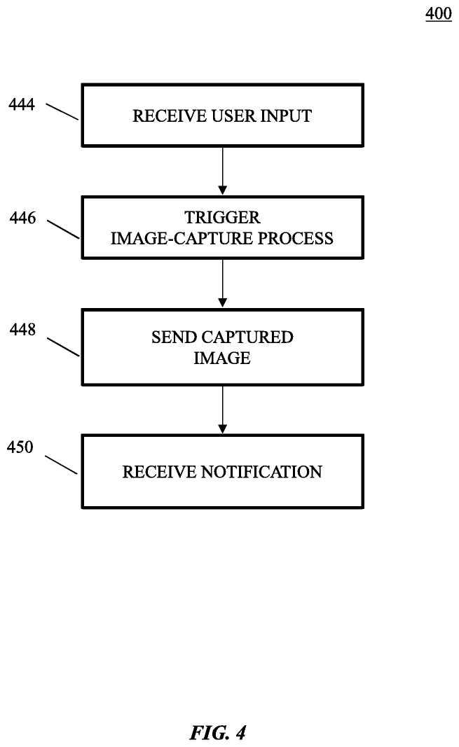

FIG. 4 is a flowchart illustrating another example method 400 of virtually depositing paper currency, consistent with some embodiments of the present disclosure. In some embodiments, method 400 may include: in step 444, receiving user input; in step 446, triggering an image-capture process; in step 448, sending a captured image; and in step 450, receiving a notification. Example method 400 may be implemented in a computing environment (see, e.g., FIG. 1) using one or more computer systems (see, e.g., FIG. 5). In some embodiments, method 400 may be performed by one or more devices 106.

In step 444, user input may be received. For example, a device may receive user input indicating that the user wishes to virtually deposit paper currency. In some embodiments, the user input may be received when a user opens an application associated with a financial institution, and selects an option to virtually deposit paper currency. In some embodiments, the user input may be received when the user logs into a banking account on a website and selects an option to virtually deposit paper currency.

In step 446, an image capture process may be triggered. For example, in response to the user selection in step 444, the device may activate a camera on the device, so that a user may take a photo of a front, back, or front and back of paper currency. In some embodiments, the user may take a photo of multiple bills of paper currency laid out in a two-dimensional grid. The bills could be of the same denomination, or of varying denominations.

In step 448, the captured image may be sent. For example, the device may send the captured image over network(s) 104 to server(s) 102. In some embodiments, a user may enter information that is sent with the image. For example, a user may enter a total value of the bills in the captured image, a number or bills by denomination, or other information. Server(s) 102 may then perform image recognition on the bills to determine one or more distinguishing features of the bills. For example, server(s) 102 may determine one or more of a denomination, serial number, mark, writing, tear, and/or wrinkle of one or more of the bills. In some embodiments, server(s) 102 may determine a total value of the bills in the image based on distinguishing features of the bills. In some embodiments, server(s) 102 may at least determine a denomination and serial number for each of the bills in the image. In some embodiments, server(s) 102 may compare the distinguishing features of the bills with a database to determine whether a virtual deposit irregularity has occurred.

In step 450, a notification may be received. For example, if a virtual deposit irregularity has not occurred, the device may receive a notification over network(s) 104 from server(s) 102 indicating that the value of the paper currency has been credited to the user's account. The notification may further indicate a period of time in which the user is expected to physically deposit the bills that were virtually deposited, or to physically deposit bills of a value in the amount of the bills that were virtually deposited. In some embodiments, if a virtual deposit irregularity has occurred, the device may receive a notification over network(s) 104 from server(s) 102 indicating that virtual deposit of the paper currency has been denied. In some embodiments, the notification may indicate a reason that virtual deposit of the physical currency has been denied.

FIG. 5 illustrates an example computer system 500 for implementing embodiments and features consistent with the present disclosure. Computer system 500 may include one or more computing devices 552. A computing device may include one or more processors 554 for executing instructions. Processors suitable for the execution of instructions include, by way of example, both general and special purpose microprocessors, and any one or more processors of any kind of digital computer. A computing device 505 may also include an input/output (I/O) device 556. By way of example, I/O devices 556 may include keyboards, scanners, keys, buttons, mice, joysticks, styluses, gesture sensors (e.g., video cameras), motion sensors (e.g., infrared sensors, ultrasound sensors), or voice sensors (e.g., microphones). Keys or buttons may be physical or virtual (e.g., provided on a touch screen interface) or both.

A computing device 552 may include one or more storage devices configured to store data or software instructions, or both, used by processor(s) 554 to perform operations consistent with the disclosed embodiments. For example, a computing device 552 may include main memory 558 configured to store one or more software programs that, when executed by processor(s) 554, cause processor(s) 554 to perform functions or operations consistent with disclosed embodiments. By way of example, main memory 558 may include NOR or NAND flash memory devices, read only memory (ROM) devices, or random access memory (RAM) devices. A computing device 552 may also include storage media 560. By way of example, storage media 560 may include hard drives, solid state drives, tape drives or redundant array of independent disks (RAID) arrays. Although FIG. 5 illustrates only one processor 554, one I/O device 556, one main memory 558, one storage medium 560, one display 562 and one communications interface 564, it will be understood that computing device 552 may include a plurality of any of these elements. Further, although FIG. 5 illustrates main memory 558 and storage medium 560 as part of computing device 552, main memory 558, storage medium 560, or both may be located remotely and computing device 552 may be able to access main memory 558, storage medium 560, or both via a network.

Storage medium 560 may be configured to store data, and may store data received from server 102, database 116, or client devices 106. The data may take or represent various content or information forms, such as documents, textual content, graphical content, or any combination thereof. The data may further include other data received, stored, or inferred by computer system 500, such as user preference information or any other data used for carrying out embodiments of the present disclosure.

A computing device 552 may also include one or more displays 562. Display(s) 562 may one or more display panels, which may include, for example, one or more cathode ray tube (CRT) displays, liquid crystal displays (LCDs), plasma displays, light emitting diode (LED) displays, organic light emitting diode (OLED) displays, touch screen displays, projector displays (e.g., images projected on a screen or surface, holographic images, etc.), field emission displays (FED), active matrix displays, vacuum fluorescent (VFR) displays, 3-dimensional (3-D) displays, electronic paper (e-ink) displays, micro displays, or any combination of the above types of displays.

A computing device 552 may further include one or more communications interfaces 564. Communications interface(s) 564 may allow content, software, data, messages, and other information to be transferred between server(s) 102, database(s) 116, and client device(s) 106. Examples of communications interfaces 564 may include a modem, a network interface card (e.g., an Ethernet card), a communications port, a personal computer memory card international association (PCMCIA) slot and card, or an antenna. Communications interface(s) 564 may transfer software, content, data, messages, or other information in the form of signals, which may be electronic, electromagnetic, or optical. The signals may be provided to or from communications interface 564 via a communication path (e.g., network 104), which may be implemented using wired, wireless, cable, fiber optic, radio frequency (RF) or other communication channels.

A computer system 554 may have additional or fewer components depending on whether the computer system is a client device 106, server 102, database 116, or ATM 118. For example, a server 102 or database 116 may not have I/O device 556. A server 102 may also not have a display 562.

The subject matter disclosed herein can be implemented in digital electronic circuitry, or in computer software, firmware, or hardware, including the structural means disclosed in this specification and structural equivalents thereof, or in combination of them. The subject matter disclosed herein can be implemented as one or more computer program products, such as one or more computer programs tangibly embodied in an information carrier (e.g., in a machine readable storage device), or embodied in a propagated signal, for execution by, or to control the operation of, a data processing apparatus (e.g., a programmable processor, a computer, or multiple computers). A computer program (also known as a software program, software application, or code) can be written in any form of programming language including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps and the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of computer programs includes, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, certain computers might also include, or be operatively coupled to receive data from or transfer data to, or both, one or more mass storage devices for storing data, e.g., magnetic magneto optical disks, or optical disks. Information carriers suitable for embodying computer program instructions and data include all forms of nonvolatile memory, including by way of example semiconductor memory devices (e.g., EPROM, EEPROM, and flash memory disks), magnetic disks (e.g., internal hard disks or removable disks), magneto optical disks, and optical disks (e.g., CD and DVD disks). The processor and memory can be supplemented by, or incorporated in, special purpose logic circuitry.

To provide interaction with the user, some subject matter described herein can be implemented on a computer having a display device, e.g., a CRT (cathode ray tube) or LCD (liquid crystal display) monitor, for displaying information to the user, and a keyboard and pointing device (e.g., a mouse, trackball, touchscreen), by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

Some subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter disclosed herein), or a combination of such back end, middleware, and front end components. The components of the system can be interconnected by any form of medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the foregoing description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A computer-implemented method for virtual deposit of paper currency, comprising:
receiving, by a computer system comprising a processor, an indication from a device of a virtual deposit of paper currency to an account;
receiving, by the computer system, an image of the paper currency from the device;
identifying, by the computer system, a value of the paper currency from the image;
identifying, by the computer system, a distinguishing feature of the paper currency from the image;
determining, by the computer system, whether a virtual-deposit irregularity has occurred by comparing the distinguishing feature with information stored in a database;
in response to determining whether the virtual-deposit irregularity has occurred, crediting, by the computer system, the account with at least a portion of the value of the paper currency;
providing, by the computer system to the device, a notification of a time period for physical deposit of the paper currency;
receiving, by the computer system, an indication that a user is attempting to complete the virtual deposit by physically depositing the paper currency;
determining, by the computer system, whether a completion irregularity has occurred in response to the indication that the user is attempting to complete the virtual deposit; and
providing, by the computer system to the device, a notification regarding whether the virtual deposit was completed by physically depositing the paper currency.

2. The method of claim 1, wherein the virtual-deposit irregularity occurs in response to a determination that the paper currency has been virtually deposited at a frequency greater than a threshold target.

3. The method of claim 1, wherein the virtual-deposit irregularity occurs in response to a determination that the paper currency has been virtually deposited more than once within a defined time span from devices whose locations at a time of virtual deposit were separated by a distance greater than a target distance.

4. The method of claim 1, comprising debiting, by the computer system, the account of at least the portion of the value of the paper currency that was credited if the paper currency is not physically deposited within the time period.

5. The method of claim 1, comprising:
determining, by the computer system, that a completion irregularity has occurred in response to the indication that the user is attempting to complete the virtual deposit;
debiting, by the computer system, from the account at least the portion of the value of the virtually deposited paper currency; and
providing, by the computer system to the device, a notification of the debit to the account.

6. The method of claim 5, wherein the completion irregularity occurs in response to:
an inconsistency between the value of physically deposited paper currency and the value of the paper currency that was virtually deposited;
a determination that the physically deposited paper currency is not identical to the paper currency in the image;
an indication that the physically deposited paper currency is counterfeit; or a determination that the virtual deposit was fraudulent.

7. The method of claim 1, comprising triggering, by the computer system, a process that allows a user of the device to capture the image of the paper currency.

8. The method of claim 7, wherein the image is captured utilizing a camera built into the device.

9. The method of claim 8, wherein the image is captured through use of an application provided by an institution offering the account.

10. The method of claim 1, wherein the portion of the value and the time period are based on attributes associated with the account.

11. The method of claim 1, comprising:
receiving, by the computer system, an indication that the paper currency has been physically deposited;
crediting, by the computer system, the account of any value of the paper currency that was not already credited to the account; and
providing, by the computer system to the device, a notification of the credit to the account.

12. An automated teller machine for completing a virtual deposit of paper currency, comprising:
a memory storing instructions; and
a processor that, when executing the instructions is configured to:
receive a credential from a user associated with an account;
receive an indication that a user wishes to physically deposit paper currency that was previously deposited to the account by virtual deposit;
prompt the user to insert the paper currency corresponding to the virtual deposit;
perform image recognition on the paper currency to identify a value and a distinguishing mark of the paper currency;
send an indication of the value and an indication of the distinguishing mark over a network to a computer system; and
receive a notification over the network from the computer system indicating whether the paper currency is accepted as a physical deposit.

13. The automated teller machine of claim 12, wherein the processor, when executing instructions, is configured to present a confirmation to the user when the notification indicates that the paper currency is accepted.

14. The automated teller machine of claim 12, wherein the processor, when executing instructions, is configured to:
present information to the user that the paper currency has been denied when the notification indicates that the paper currency is not accepted; and
return the inserted paper currency to the user.

15. The automated teller machine of claim 14, wherein the notification is received in response to:
an inconsistency between the value of the paper currency and the value of the paper currency that was deposited by virtual deposit;
a determination that the paper currency is not identical to the paper currency that was deposited by virtual deposit;
an indication that the paper currency is counterfeit; or
a determination that the virtual deposit was fraudulent.

16. A computer-implemented method for virtual deposit of paper currency, comprising:
receiving, by a device comprising a processor, a user selection of an option in a software application indicating that a user wishes to deposit paper currency to an account by virtual deposit;
in response to the user selection, triggering, by the device, a process that allows the user to capture an image of the paper currency;
sending, by the device, the image of the paper currency to a computer system associated with the account; and
receiving, by the device, a notification from the computer system regarding a status of the virtual deposit, wherein the notification indicates that a virtual deposit irregularity has occurred and that the virtual deposit has not been accepted, the notification further indicating the virtual-deposit irregularity occurred in response to one of a determination that the paper currency has been virtually deposited at a frequency greater than a threshold target or a determination that the paper currency has been virtually deposited more than once within a defined time span from devices whose locations at a time of virtual deposit were separated by a distance greater than a target distance.

17-19. (canceled)

20. The method of claim 16, wherein the image is captured utilizing a camera built into the device.
